(19) United States
(12) Patent Application Publication
(10) Pub. No.: US 2002/0152152 A1
(43) Pub. Date: Oct. 17, 2002

(54) Method and system for operating a configurable trade exchange

(75) Inventors: Alejandro H. Abdelnur, Sunnyvale, CA (US); Atul Q. Batra, San Jose, CA (US); William T. Drake, Austin, TX (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Sun Microsystems, Inc.

(21) Appl. No.: 09/827,177

(22) Filed: Apr. 6, 2001

Related U.S. Application Data
(60) Provisional application No. 60/237,688, filed on Oct. 5, 2000.
(60) Provisional application No. 60/248,221, filed on Nov. 15, 2000.
(60) Provisional application No. 60/251,885, filed on Dec. 8, 2000.

(51) Int. Cl. G06F 17/60; G06N 5/02; G06F 17/00

(52) U.S. Cl. 705/37; 706/47

(57) ABSTRACT

The present invention describes a platform for trading homogenous goods. In particular, a multi-attribute market can be readily configured using the platform of the present invention to provide for an efficient value added trading exchange environment. Aspects of the disclosure include a flattening function which maps predefined order characteristics into an orthogonal, normalized dimensions space. This flattening function provides for a ready comparison between active and passive orders to evaluate a matching occurrence. Additionally, the present disclosure provides a configurable platform to support a pipe and filter approach to matching functionality including name value pair and rule based algorithms. Finally, a close match concept is disclosed whereby a market maker can increase liquidity in the market by conveniently determining closely matching orders and communicating with the market participants to facilitate a transaction.

### CROSS REFERENCE TO RELATED APPLICATIONS

This application claims benefit of U.S. Provisional Application No. 60/237,688, filed Oct. 5, 2000; U.S. Provisional Application No. 60/248,221, filed on Nov. 15, 2000, and U.S. Provisional Application No. 60/251,885, filed on Dec. 8, 2000, all of which are entitled: METHOD AND SYSTEM FOR OPERATING A CONFIGURABLE TRADE EXCHANGE, and all of which are hereby incorporated by reference.

### BACKGROUND OF THE INVENTION

1. Field of the Invention

The present invention relates to a method and system for matching an order of a homogenous good (or service) in a configurable trade exchange. In particular, the present invention relates to an improved methodology for transforming standard order format into useful dimensions and an improved methodology for matching and managing those orders.

2. Discussion of the Related Art

Computerized order matching systems are known to suffer from a variety of disadvantages. Initially, computerized order matching systems are conventionally designed and developed for specific applications and/or market environments. For example, computerized order matching in securities transactions have been developed to handle the peculiar attributes and characteristics of various securities as homogenous commodities. However, conventional order matching technology is not easily adaptable from one market to another, or for application to goods and services with differing attributes. Furthermore, the conventional order matching algorithms frequently are specifically configured for the attributes of the specific market. Conventional trading platforms fail to provide a configurable platform for trading homogenous goods.

Conventional order matching technology also fails to provide for robust and desirable information exchange between market participants. Thus, as can be appreciated, the failure to facilitate the appropriate exchange of information relating to market can decrease the effectiveness of the market and decrease market liquidity.

These and other deficiencies in conventional order matching and market making technologies reduce the value derived from the market activities for both buyers and sellers in the market.

### SUMMARY OF THE INVENTION

The present invention provides a flexible and fully customizable framework to host any kind of exchanges. In particular, the present invention matches buy and sell orders based on a plurality of attributes associated with commodities traded in the configurable trade exchange. Additionally, the present invention facilitates the ready development of matching algorithms and rules, which are configured by an exchange administrator.

In one embodiment, the invention comprises a method for matching an order of a homogenous good or service, comprising the steps of receiving an active order including a plurality of characteristics, flattening the active order to derive a plurality of normalized dimensions, determining the existence of a matching order corresponding to the active order, and matching the active order with the matching order if the matching order exists, and in accordance with a method for matching an order of a homogenous good or service, comprising the steps of receiving an active order including a plurality of characteristics, flattening the active order to derive a plurality of normalized dimensions, determining the existence of a matching order corresponding to the active order, and passivating the active order if no matching order exists, also in accordance with a method for matching an order of a homogenous good or service, comprising the steps of receiving an active order including a name-value pair, determining the existence of a matching order which includes an identical name value pair to that of the active order, and applying a rule based filter to determine whether the passive order matches the active order based upon a rule based criteria, and pricing any matched order.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a logical view of an exchange module according to the present invention;

FIG. 2 is a flow diagram of the present invention showing an order matching algorithm;

FIG. 3 is a flow diagram of a two step order matching algorithm in accordance with the present invention; and

FIG. 4 is a flow diagram showing the substeps of an order matching algorithm.

### DETAILED DESCRIPTION OF THE PREFERRED EMBODIMENTS

Reference will now be made in detail to an embodiment of the present invention, examples of which are illustrated in the accompanying drawings.

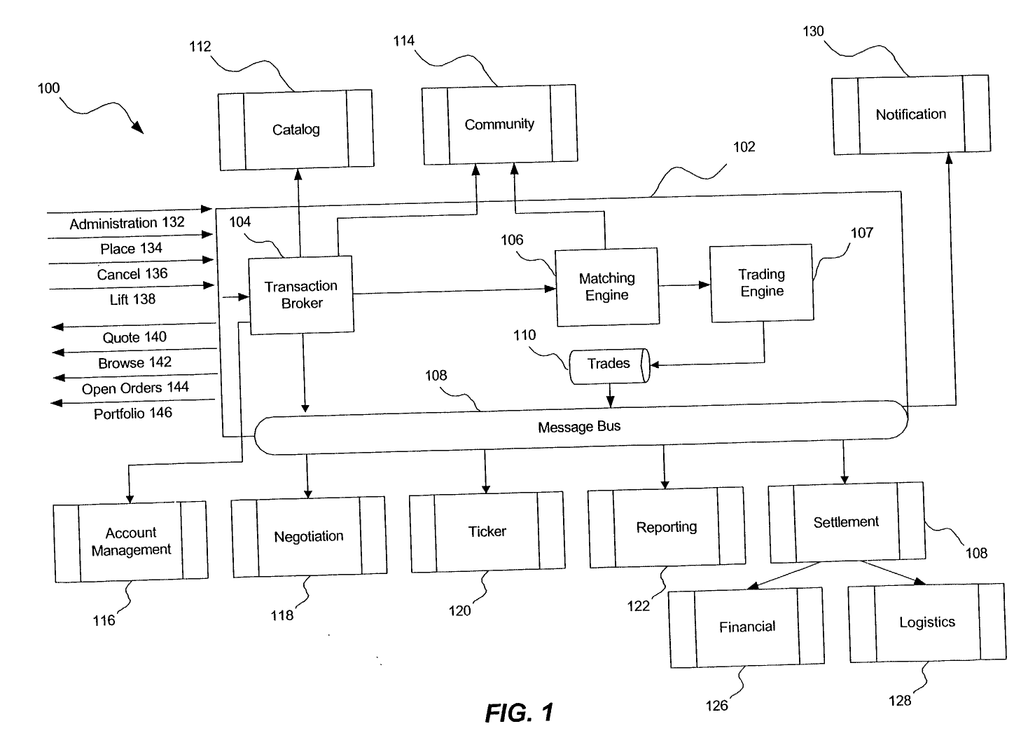

FIG. 1 shows a logical view 100 of an exchange module. Each of the functional aspects of this logical view 100 will be discussed in turn. Generally, each of the functional aspects of the logical view 100 can be modeled in the Java® (trademark of Sun Microsystems, Inc.) progamming language, e.g., a Java 2 platform with appropriate infrastructure support. These functional aspects can furthermore be distributed throughout the computing platform.

Turning to FIG. 1 in particular, the logical view 100 includes an exchange module 102, which further includes generally a transaction broker 104 and an exchange engine 106. The exchange module 102 cooperates with a messaging bus 108 through a connection with the transaction broker 104 and a connection with the exchange engine 106 via a trades data store 110.

The transaction broker 104 is connected to a catalogue unit 112 and a community unit 114, as well as to the exchange engine 106. The catalog unit 112 is the dictionary of valid homogenous items or symbols on the exchange. For example, the catalog 112 could facilitate the storage of a series of alphanumeric symbols representing specific types of cargo to be traded. The community unit 114 facilitates a desired functionality to allow the specific exchange shown in logical view 100 to interact and cooperate with another exchange (not shown) in a possibly related market or related business. The exchange engine 106 is also connected to the community unit 114 and a trading engine 107. Trading engine 107 is also connected to a data store 110 designated “trades”, as previously noted.

The transaction broker 104 is further connected to an account management unit 116. The account management unit provides functionality related to exchange participant account activities. For example, credit margin checks and credit limit checks can be facilitated through the account management unit 116. Furthermore, every order is associated with an account identifier, and that association may be facilitated by the account management unit 116.

The messaging bus 108 logically passes message between the various processes connected to it. For example, a Java Messaging Service (JMS) compliant application may be used in some applications as the messaging bus 108. In particular, the messaging bus 108 is connected to a negotiation unit 118, a ticket 120, a reporting unit 122, and a settlement unit 124. The settlement unit 124 is connected to a financial unit 126 and a logistics unit 128. After an order has been matched into final transaction, e.g., a buyer and seller have agreed to the initial terms, various functionality can be desired to continue with the regular process of settlement and closing of the transaction. As will be appreciated, appropriate user interfaces and functionality can be provided to provide these services in the negotiation unit 118, ticketing unit 120, reporting unit 122, and settlement, financial and logistic units 124, 126, and 128.

The messaging bus 108 is further connected to a notification unit 130. As explained herein, the notification unit may be used by a market maker to notify market participants of order matches which may require further negotiation between the parties before a trade takes place.

The exchange module 102 further receives a variety of inputs and outputs. In particular, the exchange module 102 may comprise general groups of inputs: receive and administration input 132, and a place input 134, a cancel input 136, and a lift input 138. The administration input 132 generally can be used to administer the exchange module by creating the exchange, suspending the exchange or configuring the exchange. Also, the administration input 132 can also set up the market participant's capability in the exchange during order creation. The lift input 138 can be used to create an inverse matching order. For example, if an active order is a sell order, having a price P for an item I, a corresponding lift input 138 would by a buy order having a price P for item I. In one embodiment, such an order may be generated by the system when a user activates a “Lift” control, such as a button on a web page.

The place, cancel, and manual match inputs 134, 136, and 138, are usable by the market participant after a registration process to manage the input of orders to the exchange. It should be noted that the lift input 138 can be used to circumvent the general exchange engine functionality to preselect a buy/sell transaction and to facilitate that match through the exchange module 102. The exchange module 102 may provide as outputs an output 140, a browse output 142, an open orders output 144, and a portfolio output 146. These functions may provide output to market participants through appropriate user interfaces to receive quotes for orders to browse orders, to view the user's open order and to view the user's portfolio, respectively.

In general, the transaction broker receives the active orders from the market participants and prepares them for entry into the exchange engine 106. The exchange engine 106 processes each active order to determine the existence of a matching order from a set of passive orders stored in a data store (NOT SHOWN). The active order and the matching passive order are then passed to the trading engine 107 which is responsible for the pricing and netting of orders. The active order is then passed to the trades unit 110. If the active order is not matched with a passive order by the exchange engine 106, than the active order is converted to a passive order and stored in the passive order data store.

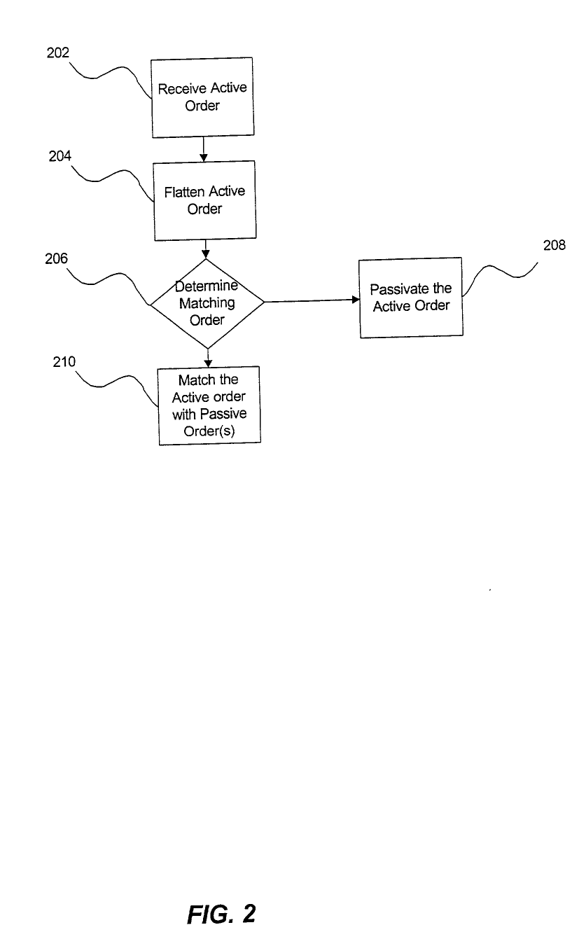

FIG. 2 shows a flow diagram 200 that is an order matching algorithm according to the present invention. In particular, the process initiates with the receipt of an active order in Step 202. The active order includes a plurality of characteristics, such as a desired price (or price range), quantity (or quantity range), quality (or quality range), life span, et cetera. Furthermore, the order can be defined as a specific type, such as a market order, a limit order, a stop limit, or a stop market order. Of course, other characteristics of the order could be input by the market participant. In one embodiment, the transaction broker 104 can be configured to receive virtually any type of characteristics with regard to the order, thus allowing for the present invention to broadly function in a wide variety of market environments.

Traditionally, the order characteristics of “price” and “quantity” for homogenous goods are considered. Another traditional criteria relates to the type of order, e.g., whether the order is a buy order or a sell order. Other characteristics or criteria could be considered.

After the receipt of the active order in 202, the process then performs a flattening function on the active order in Step 204. The purpose of the flattening function is to convert or map the various characteristics of the active order into a standardized and normalized set of dimensions for comparison with existing passive orders. In one embodiment, the dimensions are orthogonal to one another, and the variables may be continuous or discrete.

For example, in the stock market exchange contexts, a market order to purchase a 100 share lot of stock X maps to (1) a fixed security stock X in the identification dimension, (2) a range of share prices from zero to infinity in the price dimension, and (3) a fixed quantity of 100 shares in the quantity dimension. As explained in detail below, the quantity dimension could be expressed as a range of up to 100 shares if the overall order is divided and parsed into smaller quantities by appropriate functionality.

As another example, consider a stop limit order for 100 shares of security X with a stock price of $50. In this case, the characteristics of that order map to (1) a fixed security stock X in the identification dimension, (2) a $50 or less per share cost in the price dimension, and (3) a fixed quantity of 100 shares in the quantity dimension. As will be appreciated, various ranges of price quantity, quality, or other characteristics of an order could be considered and readily implemented into the transaction broker function 104.

One embodiment uses a dimensional axis value between zero and one for each axis, which may be derived from a linear function to reduce the order characteristics to within that range. The normalization function (e.g., the function that converts a first value to a second value between zero and one) may also result in variably granular or discrete data on the axes, if appropriate and depending upon the dimension. Furthermore, it should be appreciated that the flattening of a specific order could produce a definition of that order modeled by an N-dimensional volume or region in the axes space.

Decision block 206 receives the flattened active order and determines the existence of a matching order from a set of passive orders. In particular, the exchange engine 106 receives the normalized dimensions of the order, and then searches an existing data store (NOT SHOWN) of passive orders to determine whether an appropriate match occurs. As will be appreciated, the determination of whether a match occurs can be determined in several different ways. In a straightforward example, the exchange engine 106 will search through the set of passive orders and locate a passive order (or a set of passive orders) which includes a set of normalized dimensions which intersect for at least one point with the normalized dimensions of the active order. In this case, a straightforward match has been found and the active order is matched with the matching order in Step 210 of FIG. 2.

In a second example, a match could still be found even when no actual intersection exists between the normalized dimensions of the active and passive orders. In this case, Step 206 continues to calculate a “distance” between the polarity of normalized dimensions of the active order and the set of normalized dimensions for the passive orders to evaluate the relative closeness or distance with respect to the active and passive orders. As can be appreciated, the exchange engine 106 could determine that a match exists depending upon a closeness criteria, e.g., when to order are close enough to each other. Then, the exchange engine 106 could associate the active order with the matching passive order and proceed to Step 210.

In one embodiment of this second example, the market participants corresponding to the matched active and passive orders could be informed of each other's orders, e.g., by an exchange of the attributes or the normalized dimensions of the other's order, to facilitate market performance. The notification unit 130 in FIG. 1 may be appropriate for this purpose. For example, this could then allow in ensuing negotiation and resolution of any apparent discrepancies between the orders that prevented the normalized dimensions from intersecting.

A form of distance calculation in the non-overlapping example described above will now be described. The exchange engine 106 could increment the end points of the normalized dimensions of the active order by an amount, Δ. Thereafter, the normalized dimensions of the active order plus Δ could be compared with the set of passive orders to evaluate whether an intersection exists. If no intersection occurs, the normalized dimensions of the active order could be incremented by 2×Δ, and the comparison re-executed. This process can be repeated until an intersection is detected. Thus, a measure of the distance may be determined by the total increment of Δ from the original normalized dimensions of the active order that is needed to achieve an intersection. Of course, the amount of weight of the Δ could be varied for each dimension as desired by the exchange administer to achieve optimum order matching efficiencies.

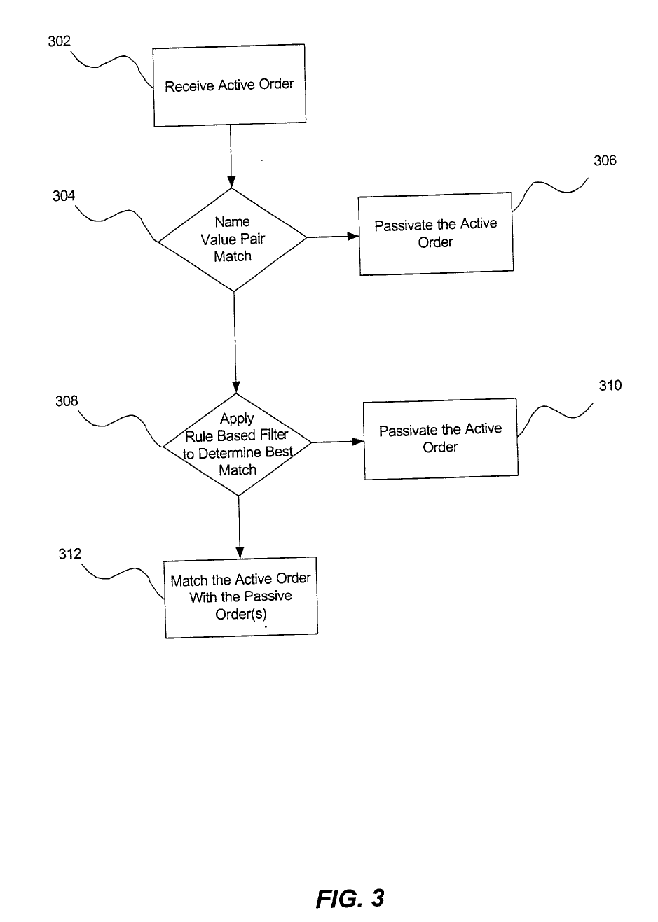

FIG. 3 shows a flow diagram for a second method for matching an order which includes a name value pair.

The order matching algorithm 300 begins by receiving an initial order 302, similar to step 202 in FIG. 2. Step 304 determines the existence of a matching order that includes a name value pair for the active order in 302. In one embodiment, the name value pair match can be similar to the matching calculation in 206 of FIG. 2, described above. Additionally, a flattening function (not shown) may be interjected between steps 302 and 304 in FIG. 3 to facilitate this matching algorithm. Of course, it is not required that the flattening function be utilized in the invention of FIG. 3. In the event that a match is not found, the active order is passivated in step 306.

In the event that a match is found, the exchange engine 106 continues to apply a rule based filter to determine whether a match occurs in step 308. In particular, the application of step 308 may be advantageously utilized to satisfy additional criteria to the market participants prior to consummating a transaction. For example, if the offering party has a specified list of buying parties with which it will only deal, step 308 could apply that rule based filter to determine whether a match occurs. This so-called “pipe and filter” approach can be configured to allow a separate data set of passive orders to be associated with each filter stage within the exchange engine 106. Of course, other rule based analysis could be applied to achieve an optimal match, e.g., a preferred customer. Moreover, additional filtering stages could be considered as desired, including conventional rule based software modules, to achieve optimum matching performance.

In the event that a match does not occur in step 308, the active order is passivated in step 310. Step 312 matches the active order with the passive order, and the process proceeds to settlement (not shown). It should be appreciated that the embodiment of FIG. 3 could equally apply the technique described above in FIG. 2 with regard to nonintersecting matches. Furthermore, the notification function described above with such nonintersecting matches could also be implemented.

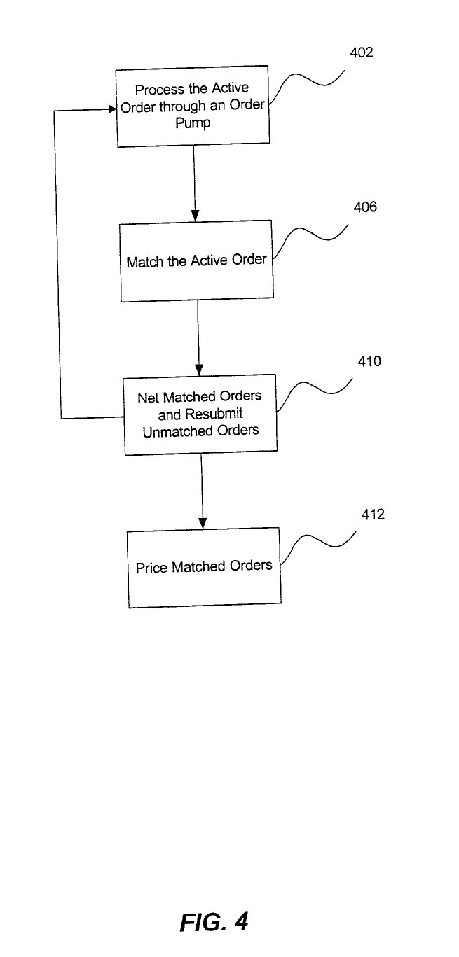

FIG. 4 shows a series of substeps which may be implemented in the determination blocks of steps 206 and 304, as described herein. In particular, the process 400 in FIG. 4 may be employed to manage and manipulate the subdivision and parsing of the orders with respect to the normalized dimensions. For example, the process 400 could be used to break an order with a quantity dimension of 100 into two “sub” orders with a quantity dimension of 50. Furthermore, the process 400 provides a functionality to assist the matching function in selecting a match where many possible matches are available.

Turning to FIG. 4, the active order is received and processed through an order pump 402. In one embodiment, the order pump (not shown) may be provided a sequence number to each active order on receipt. The value of the sequence number indicates relative priority in the matching operation. Of course, it should be appreciated that the order pump could simply assign sequence numbers based upon the known first in/first out technique, last in/first out, or other batch processing techniques.

FIG. 4 shows a series of sub-steps which may be implemented in the Steps 206 and 304 as described herein. In particular, the process 400 shown in FIG. 4 may be employed to match the active order with one or more passive orders. This matching function may subdivide an order. For example, the process 400 may break an order with a quantity dimension of 100 into two “sub” orders with a quantity dimension of 50. Furthermore, the process 400 provides functionality to assist the matching function in selecting a match where many possible matches are available.

In FIG. 4, the active order is received and processed through an order pump 402. In one embodiment, the order pump (NOT SHOWN) may provide a sequence number to each active order on receipt. The value of that sequence number indicates its relative priority in the matching operation. Of course, it should be appreciated that the order pump could simply assign sequence numbers based upon the known FIFO technique, LIFO, or other known batch processing techniques.

After the order is sequenced through the order pump in Step 402, it is passed to Step 406 to perform the matching function. It should be noted that the matching functionality has been described above with regard to blocks 206 and 304, and will not be repeated here. Step 410 nets the order and resubmits an order for any remaining quantity to the order pump step 402. For example, if a buy for 50 units quantity is matched against a sell of 100 units quantity, a sell of 50 units quantity is resubmitted to the order pump.

Finally, the orders are priced at step 412. For example, if a sell of 50 units is determined via step 410, the cost per unit and aggregate price may be determined at step 412.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

1. A method for matching an order of a homogenous good or service, comprising the steps of:
Receiving an active order including a plurality of characteristics;
Flattening the active order to derive a plurality of normalized dimensions;
Determining the existence of a matching order corresponding to the active order; and
Matching the active order with the matching order if the matching order exists:

2. A method for matching an order of a homogenous good or service, comprising the steps of:
Receiving an active order including a plurality of characteristics;
Flattening the active order to derive a plurality of normalized dimensions;
Determining the existence of a matching order corresponding to the active order; and
Passivating the active order if no matching order exists.

3. A method for matching an order of a homogenous good or service, comprising the steps of:
Receiving an active order including a name value pair;
Determining the existence of a matching order which includes an identical name value pair to that of the active order; and
Applying a rule based filter to determine whether the passive order matches the active order based upon a rule based criteria.

4. A method for matching an order of a homogenous good or service, comprising the steps of:
Receiving an active order including a name-value pair;
Determining the existence of a passive order that includes an identical name value pair to that of the active order; and
Applying a rule based filter to determine whether the passive order matches the active order based upon a rule based criteria.

5. The method for matching an order of claims 1 and 2, wherein the plurality of characteristics includes one or more selected from the group of:
price; quality; quantity; and time.

6. The method for matching an order of claims 1 and 2, wherein the flattening step includes mapping one or more of the plurality of characteristics to the plurality of normalized dimensions.

7. The method for matching an order of claims 1 and 2, wherein the plurality of normalized dimensions includes a set of orthogonal axes having a value from 0 to 1.

8. The method for matching an order of claims 3 and 4, wherein the determining step includes searching a set of passive orders stored in a database.

9. The method for matching an order of claims 1, 2, 3 and 4, wherein the determining step includes the step of comparing the plurality of normalized dimensions for the active order with a set of normalized dimensions for the passive orders to determine whether an intersection occurs.

10. The method for matching an order of claims 1, 2, 3 and 4, wherein the determining step includes a distance calculation between the plurality of normalized dimensions of the active order and a set of normalized dimensions for the passive orders to evaluate relatively close matches for an order.

11. The method of claims 1, 2, 3 and 4, wherein the distance calculation includes an iterative process of increasing a range associated with the plurality of normalized dimensions of the active order and comparing the increased range with a set of normalized dimensions for the passive orders to determine an intersection.

12. The method of claims 1, 2, 3 and 4, wherein the passivating step includes storing the plurality of normalized dimensions for the active order in a data store.

13. The method for matching an order of claims 1, 2, 3 and 4, wherein the name value pair includes data identifying the homogenous good or service and data relating to the value of the homogenous good or service.

14. The method for matching an order of claims 1, 2, 3 and 4, wherein the determining step includes calculating an intersection between the plurality of normalized dimensions of the active order and a set of normalized dimensions of the matching order.

15. The method for matching an order of claims 1, 2, 3 and 4, wherein the rule based filter rejects a match between the active and passive orders which include identical name value pairs.

16. The method for matching an order of claims 1, 2, 3 and 4, further comprising the step of notifying an entity associated with the active/passive orders of their mutual existence if the distance calculation meets a predefined criteria.

17. The method for matching an order of claims 1, 2, 3 and 4, further comprising the step of aggregating a set of orders.

18. The method for matching an order of claims 1, 2, 3 and 4, further comprising the step of deaggregating and resubmitting a remainder order after a match has been completed.
